(19) United States
(12) Patent Application Publication
(10) Pub. No.: US 2017/0358005 A1
(43) Pub. Date: Dec. 14, 2017

(54) DIGITAL DISCOUNT REDEMPTION SYSTEM

(71) Applicant: JAMII, INC., New York, NY (US)

(72) Inventors: Duc Tran, New York, NY (US); Joe Barbetta, Englewood, NJ (US)

(21) Appl. No.: 15/521,072

(22) PCT Filed: Oct. 23, 2015
(86) PCT No.: PCT/US2015/057133

§ 371 Date: Apr. 21, 2017

Related U.S. Application Data
(60) Provisional application No. 62/067,932, filed on Oct. 23, 2014.

(51) Int. Cl. G06Q 30/02; G06Q 20/40; G06Q 20/38

(52) U.S. Cl. CPC G06Q 30/0269; G06Q 30/0238; G06Q 20/387; G06Q 20/40

(57) ABSTRACT

A device and systems for generating, tracking, distributing, and redeeming digital discounts are described. A consumer collects digital offers, or coupons, through an application on a mobile device. At the point of sale, the consumer's mobile device communicates with a transceiver unit wirelessly to deliver the list of collected coupons. The transceiver unit communicates with a component installed between a point of sale scanner and a point of sale terminal. The component communicates with a server to download additional offers that apply to the consumer's purchases. The component then delivers all applicable offers to the point of sale terminal to be applied. The digital offers may be distributed through a digital coupon exchange or may be delivered through an integration with broadcast television.

### CROSS-REFERENCE TO RELATED APPLICATION

This application claims priority to U.S. Provisional Application Ser. No. 62/067,932 filed Oct. 23, 2014 and titled “Digital Coupon Methods,” the contents of which are hereby incorporated by reference.

### FIELD OF THE INVENTION

This invention relates generally to the field of digital coupons and a device installed at a point of sale terminal for interfacing with a customer's mobile device and for causing appropriate digital coupons to be applied to the customer's purchases.

### BACKGROUND

People like to use coupons to save money and manufacturers and stores frequently use coupons to entice people to buy their products. However, cutting out and collecting paper copies of coupons and bringing them to the store can become tedious. Digital coupons are being created, generated, and distributed by various manufacturers and retail stores. There is a need for a universal digital coupon platform that can be used to create and distribute coupons. Such a platform could be used by consumers to collect and organize coupons, as well as to redeem the coupons.

There is also a need for a device that can be incorporated into point of sale (POS) systems that may interact with various mobile devices to redeem digital coupons collected by the consumer. Such a device is more efficient than paper coupons, because all coupons could be applied electronically as opposed to requiring a cashier to scan individual coupons.

There is also a need for a system that integrates sales circulars or other information about product sales with coupons collected by the consumer. Such a system could notify the consumer that products discounted by collected coupons are on sale at a certain store.

### SUMMARY

The invention pertains to techniques and systems for applying digital coupons to a consumer's purchases at a point of sale. A consumer's mobile device, such as a smartphone, collects digital coupons. For example, the consumer's mobile device can download the digital coupons over the Internet. In another example, the consumer's mobile device can scan codes on paper coupons in order to generate the digital coupons.

At the point of sale system incorporating a cash register or terminal and a price scanner in a retail store, the consumer's mobile device wirelessly connects with a device that is interposed in the transmission stream between the point of sale terminal and a price scanner. The point of sale terminal receives, from the mobile device, information indicating the coupons that have been collected on the mobile device. As the products that the consumer is purchasing are scanned by the point of sale scanner, the point of sale scanner transmits the universal product code (UPC) to the digital discount redemption component (also referred to herein as a component), which then forwards the UPC to the point of sale terminal.

The component gathers digital coupons for all products to which those coupons are related. For each product that was scanned, the component determines whether a digital coupon for that product was received from the mobile device. Additionally or alternatively, the component can download, over networks, from a remote server, digital coupons that are applicable to the scanned products. The component sends the applicable coupons to the point of sale terminal, which then adjusts the prices of the products being purchased to reflect the discount resulting from the coupons' redemptions. The mobile device can send, over networks, notification to a remote server information indicating which digital coupons were redeemed.

Manufacturer coupons or retailer coupons may be distributed online through a website or through an application on a mobile device. Relevant coupons may be offered to the participating content publishers. For example, if a website is geared toward infant and early child care, the digital discount redemption system may distribute coupon offers for infant and baby products, such as diapers, wipes, infant formula, baby food etc. to the website. In one example, coupon offers may be driven by a keyword or a related keyword. If the keyword is in an article then a logo or other icon for the system may appear next to the word or as a hyperlink to indicate that a coupon is available. If the keyword is in a recipe, then the system logo or other icon may appear next to the ingredients in the ingredients list. When the consumer clicks or hovers over the system logo or icon, a coupon or list of coupons may appear.

In another example, a coupon may appear as a regular coupon on a coupon website or in the application on the mobile device. Selecting the coupon may cause the coupon to be downloaded to a shopping list on the user's mobile device.

In a further example, the system logo or icon may be embedded in a banner ad or a video. When the user clicks the banner ad or views the video, the coupon or list of coupons may appear. At this point, the coupon becomes selectable. When the user selects the coupon, it is downloaded to a shopping list on the user's mobile device.

### BRIEF DESCRIPTION OF THE DRAWINGS

These and other features, aspects, and advantages of the present disclosure are better understood when the following Detailed Description is read with reference to the accompanying drawings, where:

FIG. 1 is a diagram that illustrates an example of a system for digital discount redemption.

FIG. 2 is a diagram that illustrates an example of a technique for digital discount redemption.

FIG. 3 is an example of a coupon album to be used in building a shopping list.

FIG. 4 is an example of a shopping list, organized according to category.

FIG. 5 is an example of a mapping function.

FIG. 6 is an example of a store circular.

FIG. 7 is a diagram that illustrates an example of a technique for a digital coupon exchange.

FIG. 8 is a diagram that illustrates a technique for an enhanced savings program.

FIG. 9 is a diagram that illustrates an example of a system for the generation of coupons that may be distributed through a television broadcast or streaming service.

FIG. 10 is a diagram that illustrates an example of a system for the distribution of a coupon using a broadcast television integration.

### DETAILED DESCRIPTION

Aspects of this invention support the generation, distribution, and redemption of digital coupons. In one example, a consumer gathers coupons on a mobile device or in a user account. When the consumer purchases a product for which the consumer has a coupon, the coupon is provided from the mobile device to a point of sale (POS) system. Alternatively, the coupon may be provided from a remote server on behalf of the consumer. The consumer may gather coupons in a variety of ways, including selecting coupons, selecting products that have an associated coupon, receiving coupons via a messaging system, such as email or text, or receiving coupons via a user account.

### Exemplary User Interface

In one implementation, a user interface is provided via an application that may be installed on the consumer's mobile device. The user interface prompts the user to enter a user identification to access and manage a user account. When the user is logged into the account, the user is able to select various profile settings, including the enabling/disabling of the receipt of notifications of new coupons or sales, pending coupon expirations, the renewal of expired coupons, new store circulars, notifications of enhanced savings, notifications of shared coupons, and time sensitive coupons from a manufacturer or retailer. The user is also able to enable/disable social media settings to facilitate the distribution and sharing of coupons with other users and to enable/disable location information.

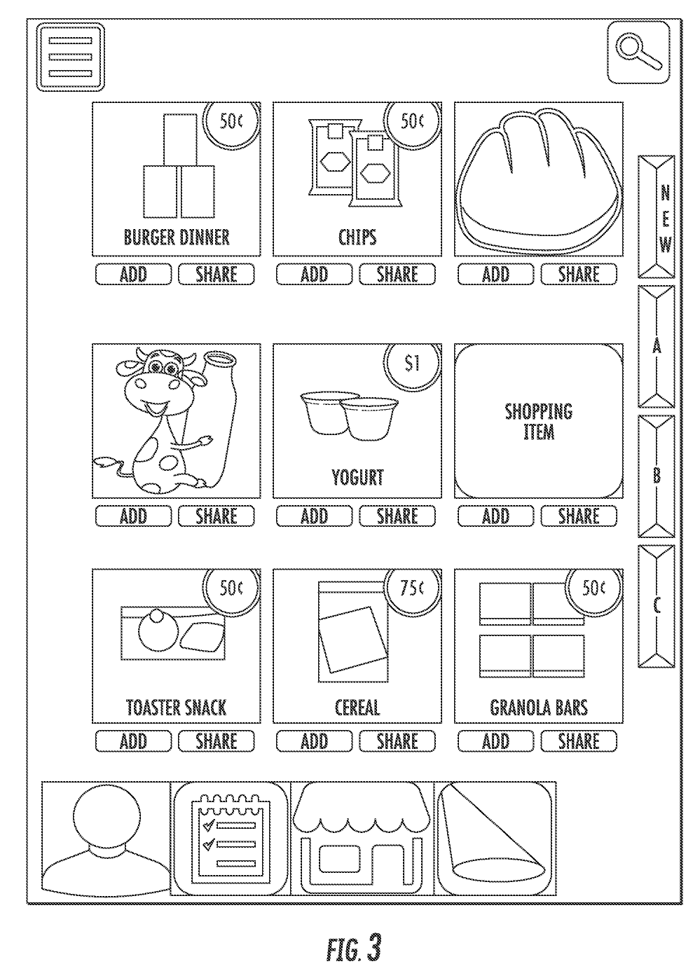

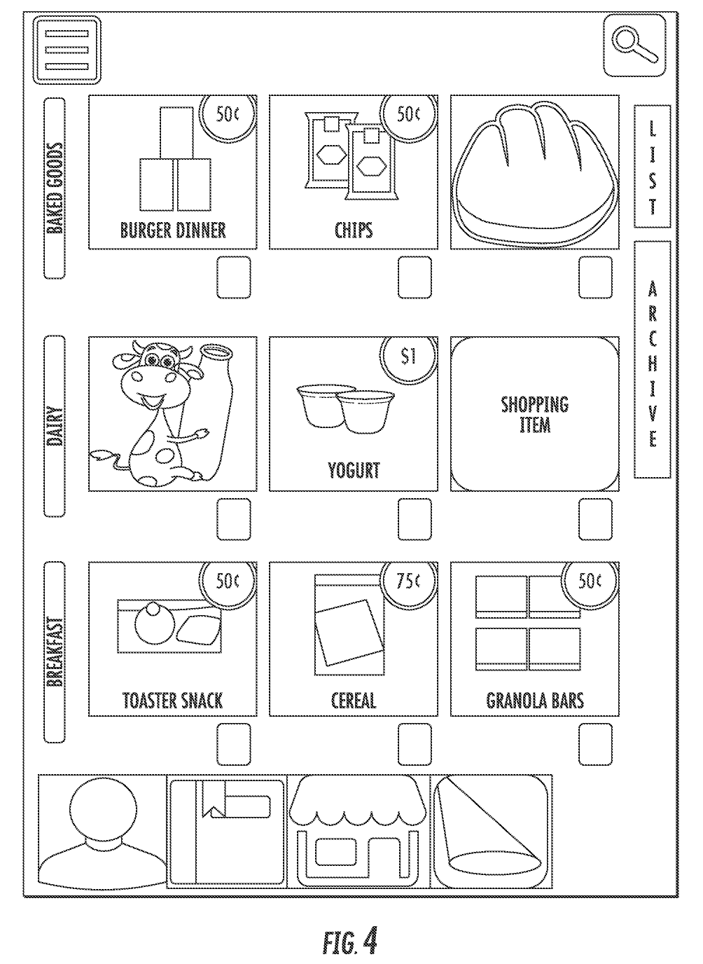

In one implementation of the application, the user is able to browse a coupon album, as shown in FIG. 3, for products and select a product to add to a shopping list. The coupon album sorts products according to retailer, category, or manufacturer. The coupon album also may have a “New” tab which the user can select to see coupons that have been recently added to the coupon album. The user is able to browse products, and select coupons to add to the shopping list. In this implementation, the shopping list is image based, as shown in FIG. 4. Items in the shopping list are organized according to category. The user is able to check off each item as the items are collected throughout the store. The shopping list can alternatively be sorted by the retailer.

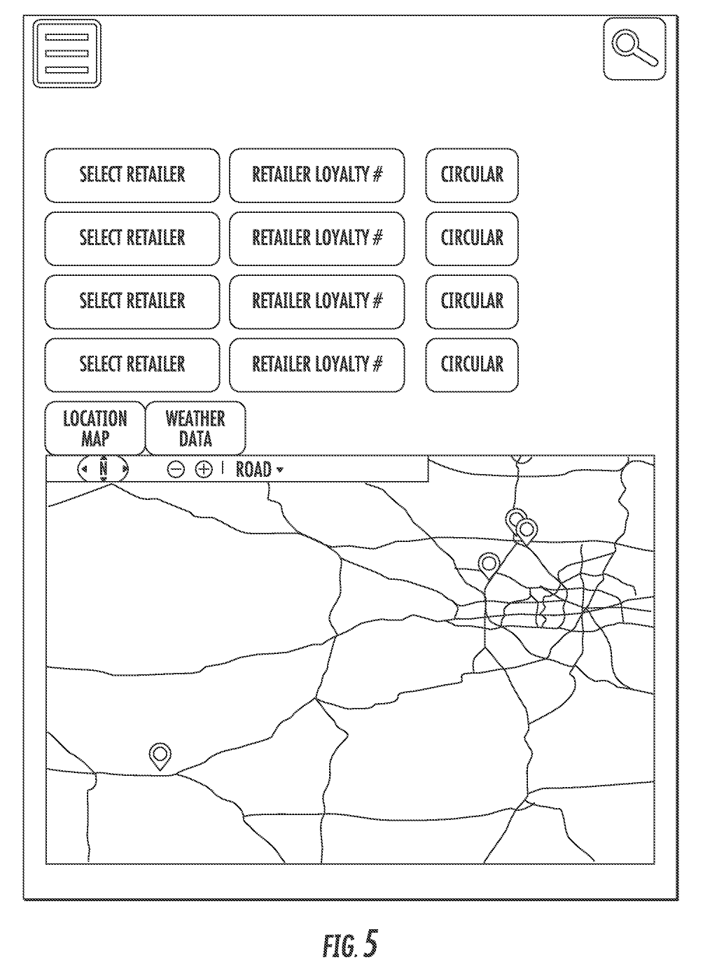

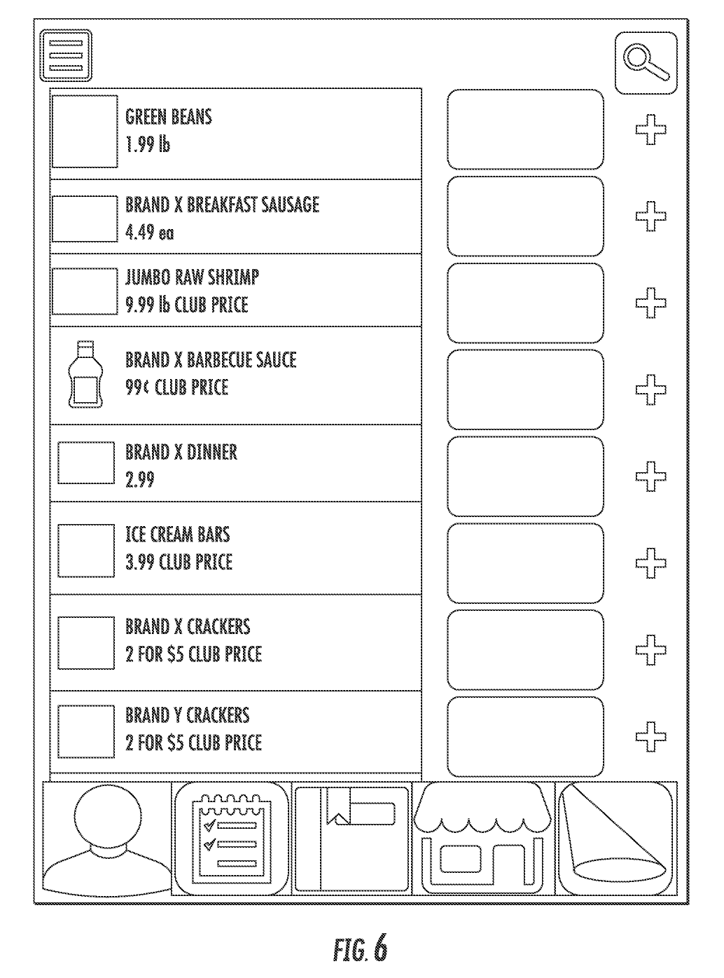

The application also includes a mapping function, as shown in FIG. 5. The mapping function allows the user to access circulars, or sales flyers, for stores in a certain geographic area. The geographic area can be based on the zip code in the user's profile or the user's current location. An example of a store circular is shown at FIG. 6. Once the user has selected a circular for a store, the user is able to select an item in the circular and add it to the user's shopping list. Items in the store circular for which coupons are also available in the coupons database may have a coupon indicator.

An incorporated social media manager allows the user to share coupons with other users and to receive coupons shared by other users.

An incorporated coupon scrap book allows the user to save recipes, helpful hints, or other information that could be included with a coupon. The user is able to add the information to the scrap book for later reference.

### Contactless Digital Redemption

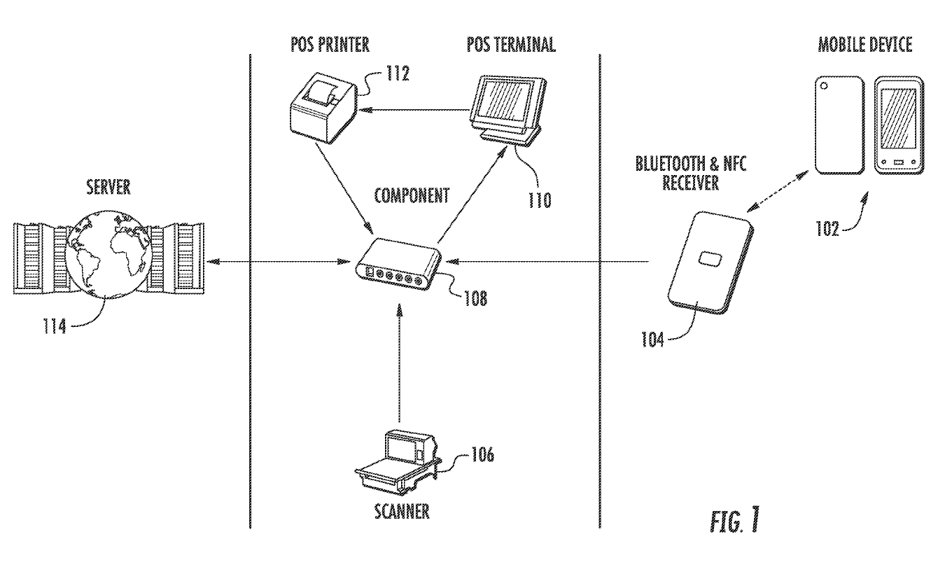

FIG. 1 illustrates an example of a system for digital coupon redemption. The system may be connected to an existing POS system that includes a scanner 106, a POS terminal 110, and a POS printer 112. The system includes a component 108 and an associated digital discount redemption transceiver unit 104 (also referred to herein as a transceiver unit). The component 108 communicates with a digital discount redemption server 114 (also referred to herein as a server), as well as with the POS system and the user's mobile device 102. The associated transceiver unit 104 facilitates the communication between the user's mobile device 102 and the component 108. Although not shown in FIG. 1, the mobile device may also communicate with the server 114 without using the component 108.

The transceiver unit 104 is able to send and receive wireless communications to the consumer's mobile device 102 using a variety of wireless communication technologies, including near field communication (NFC), Bluetooth, Bluetooth low energy (BLE), and audio information transfer. In the case of audio information transfer, the transceiver unit contains a microphone incorporated with a tone decipherer that receives signals from the mobile device 102 and a tone generator to send signals to the user's mobile device 102. In one example, the tones used to transfer information use frequencies that are inaudible to the human ear. The communications may include information identifying the user, information identifying one or more products, such as UPC information, and information identifying applicable discounts.

In an alternative example, the transceiver unit 104 communicates with the user's mobile device 102 using Quick Response (QR) codes. The transceiver unit 104 incorporates a device capable of reading a QR code. The user's mobile device 102 sends information for the coupons collected by the user as a QR code. At the time of purchase, the user positions the mobile device 102 near the transceiver unit 104 so that the QR code can be read by the transceiver unit 104. If a single QR code cannot include information for all of the collected coupons, then multiple QR codes are used.

Each time the user conducts a transaction, the user's mobile device 102 sends a signal to the transceiver unit 104 and the transceiver unit 104 responds with an acknowledgement. In this way, the mobile device 102 and the transceiver unit 104 are paired for the period of time required to complete the transaction. At the conclusion of the transaction, the transceiver unit 104 closes the connection with the user's mobile device so it will be available to connect with the next user's mobile device. The user authentication information may be cached by the transceiver unit 104 to enable future transactions with that user to be more efficient. The transceiver unit 104 may also have an interface, such as a touchscreen, that allows the user to directly enter the authentication information without the use of a mobile device.

The transceiver unit 104 sends the collected discount information on the user's mobile device to the component 108. The component 108 is connected to the point of sale scanner 106 and the point of sale terminal 110. In one example, the component 108 is located between the point of sale scanner 106 and the point of sale terminal 110 and intercepts UPC information as it is sent from the scanner to the POS terminal. In another example, the component 108 is attached to the point of sale terminal 110 but not to the point of sale scanner 106.

When a network connection is available, the component 108 and/or the transceiver unit 104 sends user information, user collected coupon information, and UPC information to the server 114. The server 114 searches for any additional discounts that may be available and returns information regarding any such additional discounts to the component 108 and/or the transceiver unit 104. In the case where the user enters the authentication information directly into the transceiver unit 104, the component 108 and/or the transceiver unit 104 sends the authentication information to the server 114, and the server 114 returns the coupons collected in the user's account, as well as additional discounts that may be available. The component 108 and/or the transceiver unit 104 communicates the available discount information to the point of sale terminal 110.

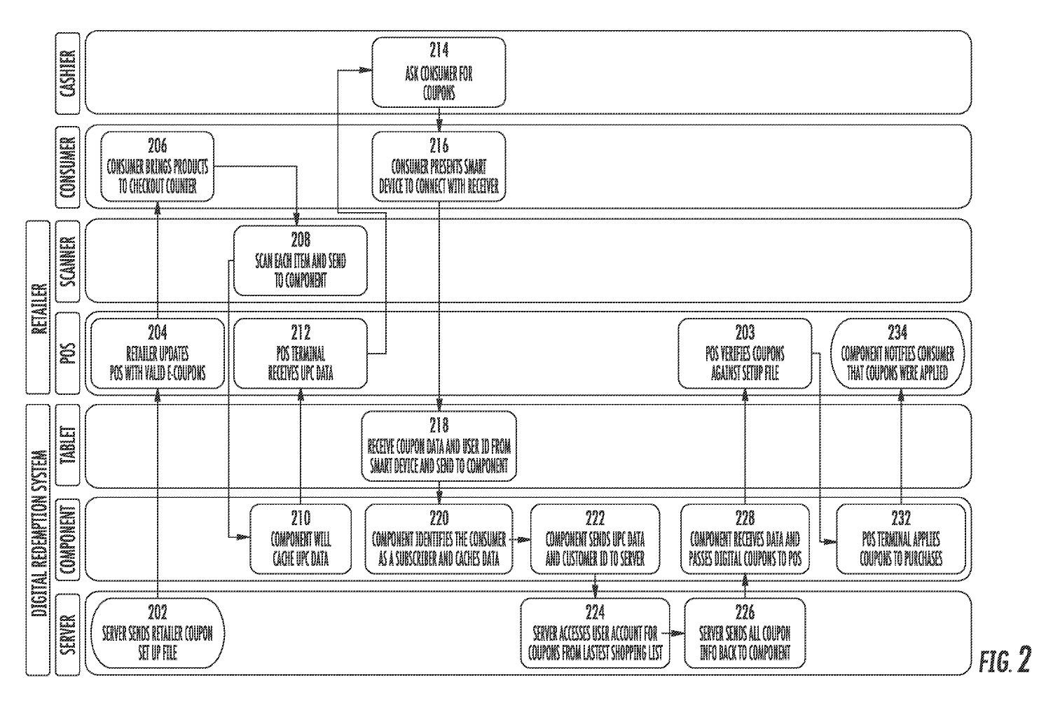

The operation of the system will be further explained in connection with FIG. 2, which illustrates an exemplary transaction. In 202, the server sends a coupon set-up file. The coupon set-up file may include information for digital discount fraud prevention. In 204, the point of sale terminal is updated with valid digital discounts.

In 206, a consumer approaches the point of sale with items the consumer intends to purchase. In 208, the items are scanned for a UPC, or other identifying mark, by the point of sale scanner.

In 210, the component and/or transceiver unit receives the UPC information from the point of sale scanner. The component and/or transceiver unit caches the identifying information for each product and builds a list of the scanned items. In 212, the point of sale terminal receives the UPC information.

In 214, the consumer is prompted for coupons to apply towards the purchases. In this example, the consumer is asked by a cashier if the consumer has any coupons to apply to the purchase. If a cashier is not present, the consumer may be prompted by the point of sale system for coupons. In 216, the transceiver unit connects to the consumer's mobile device. In one example, the consumer's mobile device initiates the connection. In another example, the transceiver unit may sense the user's mobile device by proximity and initiate the connection.

In 218, the transceiver unit receives information sent from the consumer's mobile device, including a list of coupons the consumer has collected on the consumer's mobile device that they wish to apply to the transaction and information identifying the consumer as a registered user of the system. The transceiver unit sends the information received from the consumer's mobile device to the component.

In 220, the component and/or transceiver unit verifies that the user is authorized to access the server and caches the user identification information and list of collected coupons. The component and/or transceiver unit is connected to the server through a network connection, such as an Ethernet connection. In 222, the component and/or transceiver unit sends the consumer's identification information and the list of collected coupons to the server. In 224, using the consumer's credentials, the server validates the coupons to ensure that they represent valid offers. The server also is able to determine if any additional discounts are available to the consumer. Additional discounts may be available through activity in the consumer's user account or may be available as limited time offers or other incentive programs from the manufacturer or retailer.

In 226, the server sends any additional applicable coupons to the component and/or transceiver unit. The additional applicable coupons are based on any combination of the following: the products the consumer is buying, the store the consumer is shopping at, or other activity in the user's account. The store or manufacturer coupons may include coupons that apply specifically to that consumer, that are awarded to consumers who perform certain shopping behaviors, that are limited time offers, that are awarded to all consumers shopping in the store, or that are awarded to all consumers buying the manufacturer's products. These may be coupons that the consumers would be awarded whether or not the consumer has collected them on the consumer's mobile device. In one example, the additional applicable coupons are sent according to GS1 and Association of Coupon Professional (ACP) standards.

Depending upon the system configuration, the component, transceiver unit, and/or server may determine which coupons are applicable to the consumer's purchases according to information about the purchases, such as the UPC, quantity purchased, or other requirements of each coupon. The component, transceiver unit, and/or server may verify that the coupons are valid and active. The component, transceiver unit, and/or server may verify that the consumer has performed the behaviors required to redeem the coupons, such as meeting the terms of the coupon. It is possible that the behaviors required would accrue over time or at different retailers.

In another example, the component, transceiver unit, and/or server might not perform any verification. In this case, the component, transceiver unit, and/or server would simply send all coupons accumulated by the consumer on their mobile device downloaded from the server to the point of sale terminal for processing.

In 228, the component and/or transceiver unit sends all applicable coupons to the point of sale terminal. In 230, the point of sale terminal verifies the coupons against the digital coupon set-up files to ensure that they are valid. In 232, the point of sale terminal applies the coupons to the prices of the items and computes the amount due from the customer. In 234, the transceiver unit sends notification to the consumer or the consumer's mobile device that all applicable coupons have been sent to the point of sale system. The point of sale terminal may also communicate the amount saved to the transceiver unit. The transceiver unit then generates a digital receipt for the transaction for the consumer. Alternatively, the component may deliver a digital receipt similar to a receipt generated by a point of sale receipt printer. The receipt may be communicated to the consumer's mobile device. The server may optionally store the information in the user's account for later access by the user.

The list of additional applicable coupons gathered by the server may also be sent to the consumer's mobile device so the consumer may review the additional coupons at a later date. The transceiver unit may send the notification to the consumer with a visual alert, an audio alert, or both, to indicate that the discounts were successfully applied. The transceiver unit may alternatively send the notification to the consumer's mobile device that the discounts were successfully applied. The mobile device would then send an appropriate notification to the consumer. The notification could include the amount saved using the coupons.

The foregoing example assumes that a network connection between the component and/or transceiver unit and the server is available during the transaction. If it is not, then the component and/or transceiver unit are able to receive and process coupons collected on the consumer's mobile device by using a process similar to the process described by FIG. 2, without performing steps 222, 224, and 226. In this example, the component and/or transceiver unit caches the user identification and coupon information so that when a network connection is restored, the redeemed coupon information can be sent to the server. The redeemed coupon information can then be used to track analytics.

In the example where the component is connected to the point of sale terminal, but is not connected to the point of sale scanner, the component may receive the UPC codes of the scanned items from the point of sale terminal.

### Digital Coupon Exchange

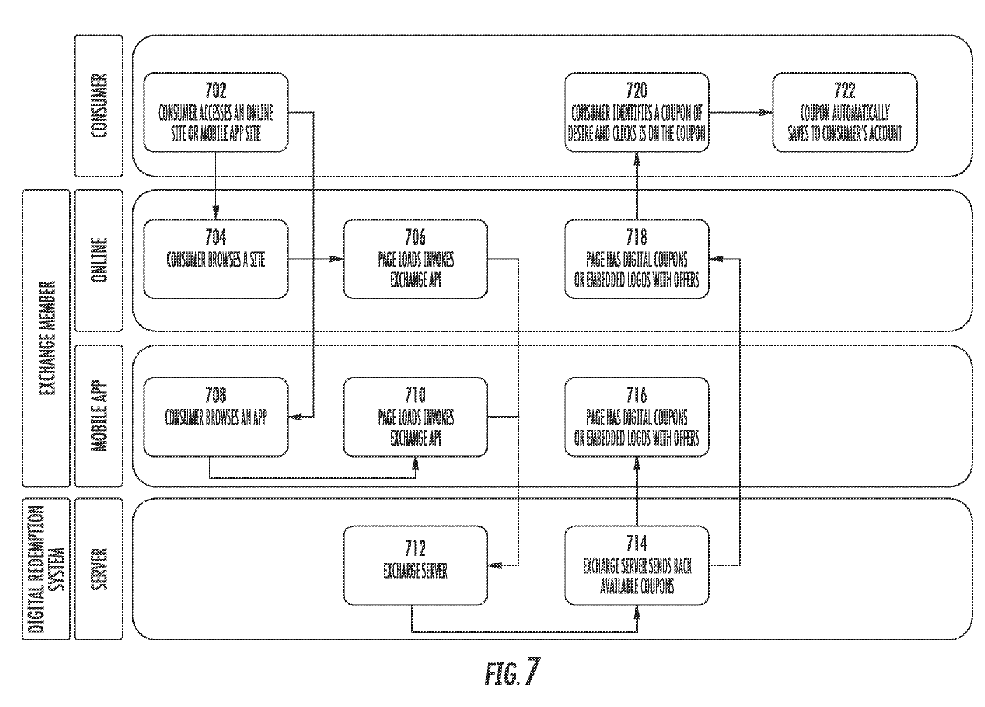

FIG. 7 is a diagram that illustrates the digital coupon exchange. Using a digital coupon exchange, coupons can be offered in a variety of ways to a user, including digital coupons, text based coupons, or as banner ads or videos. Selected coupons are added to the user account for later redemption. Coupons are accessed starting at 702 when the user accesses a website online or through a mobile application. In 704, the user navigates to an online site. In 706, the page loads invoking an API for the digital coupon exchange. The page may include a digital version of a coupon that a user is able to select. The page may also include a text based coupon. The text based coupons are accessed by an indicator, such as an icon or logo, next to a keyword. When the user clicks on the indicator, the coupon appears. The page may also include an indicator embedded in a banner advertisement or video. Similar to the text based coupon offer, the coupon appears when the user clicks on the indicator. Alternatively, the user browses an application in 708. In 710, similar to 706, the page loads invoking the API.

After the page has loaded in 706 or 710, the API invokes the server to obtain the available coupons in 712. In one example, the coupon is tied to the content the user is viewing. Because the coupons are obtained real-time, the server is able to validate coupons before delivery. In this way, the system is able to prevent the delivery of a coupon that is no longer current or appropriate. Alternatively, the system is able to replace a coupon with a different coupon or modify an existing coupon. Coupons offered might be static or dynamic. Static coupons do not have an expiration date. Static coupons may be for a lower value. Dynamic coupons, however, do have an expiration date. Dynamic coupons may be for a higher value. A retailer or manufacturer may also choose to put a cap on the total number of coupons or the total value of the coupons redeemed, whether they are static or dynamic. For example, the offeror may specify that one million coupons will be offered. Alternatively, the offeror may specify that the value of coupons redeemed should not exceed $10,000. If a user selects a coupon that has expired or reached a cap, the API may instead offer a similar offer that is still valid, if one is available.

In 714, the Exchange server sends the available coupons to the webpage or the application. In 716, the page is loaded by the application with the digital coupons or embedded logos with the available coupons. Alternatively, if the user is accessing a webpage, the page is loaded with the digital coupons or embedded logos in 718.

In 720, the user identifies a desired coupon and selects it. In 722 the coupon is saved to the user's account. The coupon is thus available when the user builds a shopping list.

### Enhanced Savings System

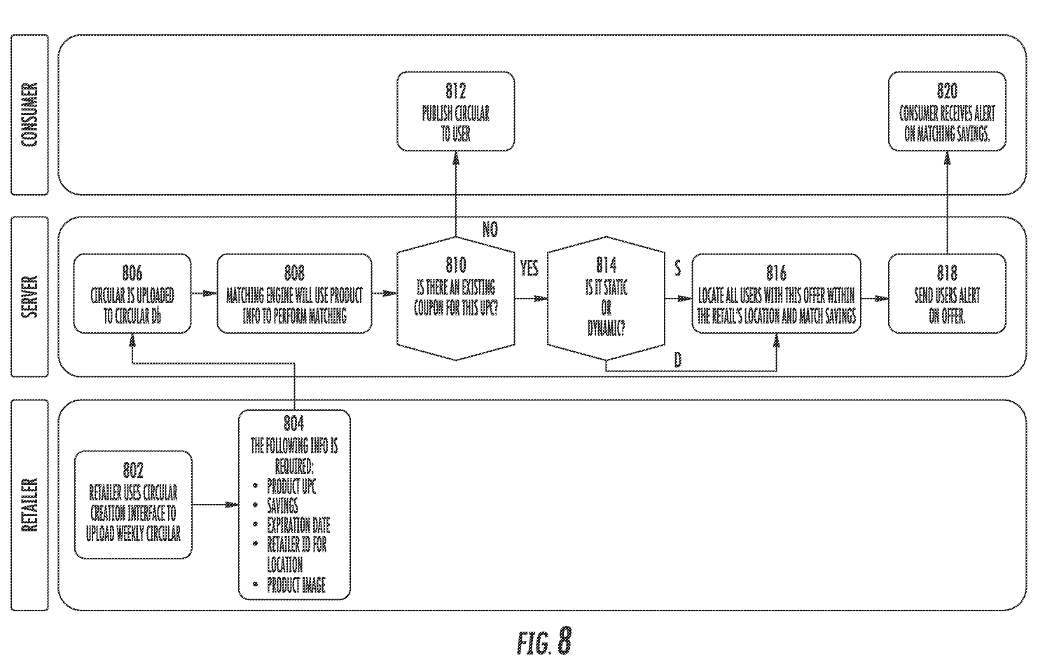

FIG. 8 is a diagram that illustrates an example of a technique for an enhanced savings program. Retailers are able to create or upload circulars featuring currently available sales into the system. Users can browse the circular to learn about sales on items of interest. Users can add items to the shopping list while browsing the circular. Users can also learn about currently available coupons for items of interest while browsing the circular.

The enhanced savings program starts when a retailer uses the circular creation interface to upload a circular at 802. In one example, the circular is weekly. The circular may have been created in the circular creation interface or it may have been imported from another application, or delivered to the system in other ways. The circular creation interface checks to be sure that the required information is included in the circular. The retailer may provide the product UPC, the savings amount, the expiration date of the sale, the retailer identification information, a product image, and a product description. In 806, the circular is uploaded to the circular database in the server.

The server analyzes the circular to see if sale items also have corresponding coupons available. In 808, the server reads the product information for the purpose of comparison. At 810, the server checks to see if there is an existing coupon for the current UPC. In one example, the items may be compared by using the UPC information for the items in the circular and the UPC information for the coupons stored in the database. In another example, pictures of the items in the circular may be compared with the pictures of items in the coupon database.

If there is not an existing coupon for the current UPC, at 812, the circular is published to the user. If there is an existing coupon available, at 814, the server evaluates whether the coupon is static or dynamic. The server also makes sure that dynamic coupons have not expired. At 816, the server locates all users with the coupon in a shopping list or a coupon album within the retailer's geographic area and matches the coupon savings with the savings offered in the circular. At 818, the server sends an alert to users regarding the enhanced savings available. At 820, the user receives the alert on the user's mobile device.

The sale information can be sent to users when one or more of the following conditions occur: at the time when the circular is uploaded to the digital discount interface system or built in the digital discount interface system, all users with a coupon for any of the items in their list of collected coupons may receive notification of the enhanced savings; as items are added to the user's list of collected coupons or shopping list or coupon album, the user may receive notification of the enhanced savings; or upon logging into the system, a user may receive notification of sales at all participating retailers within a certain distance of the user. The user can select items of interest to be added to the user's shopping list or coupon album.

### Broadcast Television Integration

Coupons can also be distributed to a user through an integration with broadcast television or other streamed content. Advertisers can sponsor certain programming by embedding a signal in advertisements that communicates with the user's mobile device. When the mobile device detects the signal, it connects to the server and downloads the applicable coupon.

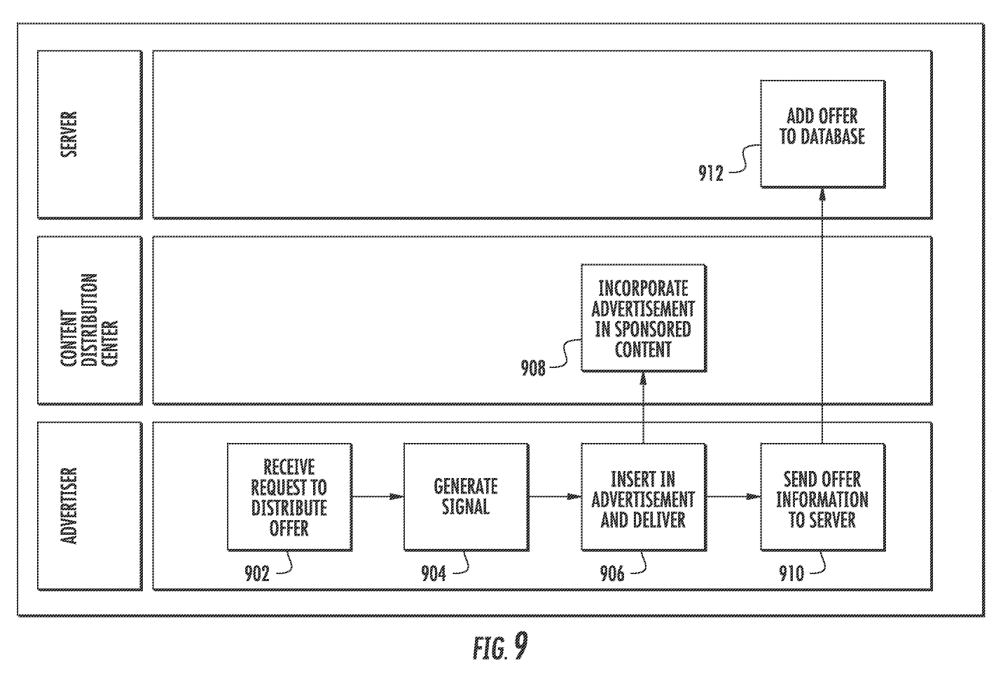

FIG. 9 is a diagram that illustrates an example of a system for the generation of coupons that may be distributed through a television broadcast or streaming service. At 902 an advertiser receives a request to distribute coupons in an advertisement. The advertiser receives the request from the manufacturer of the product, a retailer, or another entity that wishes to offer a coupon. In 904, the advertiser generates the signal for insertion into an advertisement, such as a commercial. In another example, the signal may be inserted directly into the programming. The signal may be an audio signal, a visual signal, a Bluetooth signal, a BLE signal, an NFC signal, an infrared signal, or another type of signal that can be communicated wirelessly to the user's mobile device. An audio signal may be of a frequency that is not perceptible to the human ear. A visual signal may be inserted in the vertical blanking interval. The signal includes the date and time the advertisement is scheduled to air, the broadcaster that is scheduled to deliver the advertisement, the program that is scheduled to air during the time of the advertisement, the manufacturer of the featured product, and the product's UPC.

In 906, the advertiser inserts the signal into the advertisement and delivers the advertisement incorporating the signal to the content distribution center. The content distribution center is an entity that delivers content to a user over a broadcast, cable, or satellite distribution channel. The content distribution center also may distribute content over the internet. In 908, the content distribution center incorporates the advertisement in sponsored content and broadcasts the sponsored content at the appropriate time to a viewing device, such as a television. The viewing device may be a traditional television or a smart television, containing a processor and a memory. The viewing device may also be a computing device.

At 910 the advertiser also delivers the information embedded in the signal to the server. The information is used to generate a coupon that is stored in the database. The coupon is stored in 912 along with the information regarding the airing of the advertisement described above in the description of the signal so the coupon will be referenced by the signal.

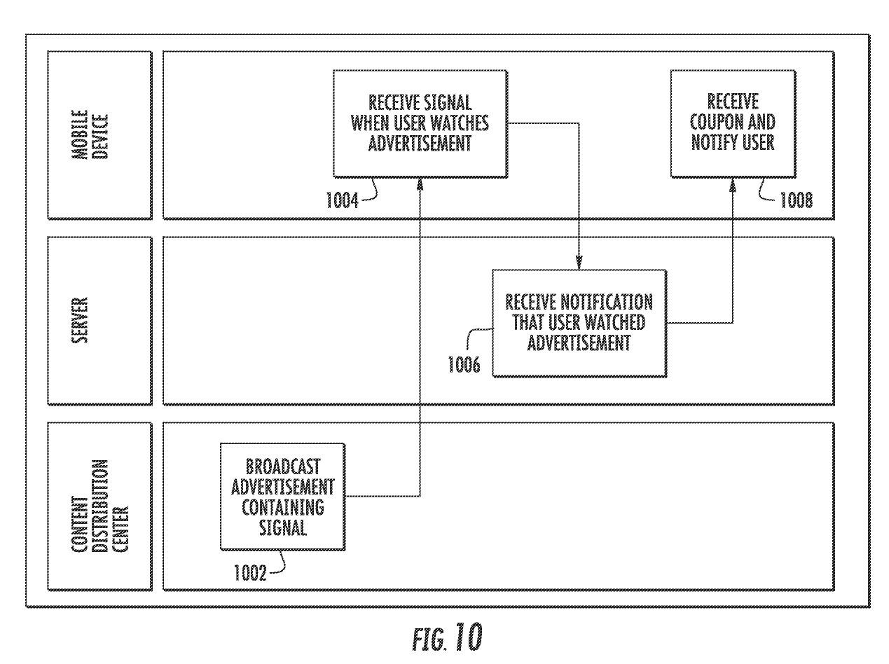

FIG. 10 is a diagram that illustrates an example of a system for the distribution of a coupon using a broadcast television integration. In 1002, the content distribution center broadcasts the advertisement containing the signal during a sponsored show. As described above, the signal may be an audio signal, a visual signal, or another type of signal. When the signal is an audio signal, the mobile device can be in any orientation but must be within range for projected sound to be detectable by the mobile device. When the signal is visual, the mobile device must be oriented such that the camera is pointed towards the viewing device.

The user's mobile device receives the signal in 1004 when the user watches the advertisement. In one example, the system application is running in the background on the mobile device and listening for a signal. When the mobile device detects the signal, it initiates communication to the server and communicates that the signal was received. At 1006, the server receives the notification from the mobile device, indicating that the user watched the advertisement. The server then looks up the coupon using the information received from the mobile device. The server also validates the associated coupon to ensure that it is still active and delivers the coupon to the user's account. For example, the coupon may only be valid if the user is watching the programming at the time the programming was scheduled to air or during another time period specified by the advertiser. In 1008, the mobile device receives the coupon and notifies the user that a new coupon has been received in the user's account.

If in 1006, the server determines that the coupon is either not a legitimate coupon or is not an active coupon, the server ends the process without sending a coupon to the mobile device or adding a coupon to the user's account.

### Analytics Gathering

The system also may gather analytics to be used in determining where to place coupons in order to target certain demographic groups. Information tracked includes the websites or applications where a coupon was collected by a user. The system may also track whether a coupon is shared over social media and how many users actually download the application and store the coupon. Users may be identified as “super” users based on how often the user shares coupons, how many coupons the user has shared, how many coupons the user has used, how many followers the user has, how much the user has saved, and what coupons the user shares. Information regarding the demographics of users who download coupons using the broadcast television integration may also be gathered and shared with broadcasters.

### General Considerations

Mobile devices may include cell phones, PDAs, tablets, and wearable devices. Mobile devices can run software such as various versions of Microsoft Windows, Apple operating systems, and/or Google Android operating systems. Mobile devices can be Internet enabled. Alternatively, mobile devices can be any other electronic device capable of communicating over a network, such as a network described below.

The system environment can further include a network. The network can be any type of network familiar to those skilled in the art. The network may support data communications using a network protocol, such as TCP/IP, SNA, IPX, AppleTalk, and the like. Merely by way of example, the network can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

The system environment can further include one or more server computers which can be general purpose computers, specialized server computers (including, e.g., PC servers, UNIX servers, mid-range servers, mainframe computers, rack-mounted servers, etc.), server farms, server clusters, or any other appropriate arrangement and/or combination. The server can run an operating system including any of those discussed above, as well as any commercially available server operating system. The server can also run any of a variety of server applications and/or mid-tier applications, including web servers, FTP servers, CGI servers, Java virtual machines, and the like.

The system environment can further include one or more databases. In one set of embodiments, the databases can include databases that are managed by the server. Databases can reside in a variety of locations. By way of example, databases can reside on a storage medium local to (and/or resident in) one or more of the computers. Alternatively, databases can be remote from any or all of the computers, and/or in communication (e.g., via a network) with one or more of these. In one set of embodiments, databases can reside in a storage-area network (SAN) familiar to those skilled in the art.

In various embodiments, a computer system can be used to implement any of the computers described with respect to the system environment above. The computer system can include hardware elements that are electrically coupled via a bus. The hardware elements can include one or more central processing units (CPUs), one or more input devices (e.g., a mouse, a keyboard, etc.), and one or more output devices (e.g., a display device, a printer, etc.). The computer system can also include one or more storage devices. By way of example, the storage device(s) can include devices such as disk drives, optical storage devices, and solid-state storage devices such as a random access memory (RAM) and/or a read-only memory (ROM), which can be programmable, flash-updateable and/or the like.

The computer system can additionally include a computer-readable storage media reader, a communications subsystem (e.g., a modem, a network card (wireless or wired), an infra-red communication device, etc.), and working memory, which can include RAM and ROM devices as described above. In some embodiments, the computer system can also include a processing acceleration unit, which can include a digital signal processor (DSP), a special-purpose processor, and/or the like.

The computer-readable storage media reader can be connected to a computer-readable storage medium, together (and, optionally, in combination with storage device(s)) comprehensively representing remote, local, fixed, and/or removable storage devices plus storage media for temporarily and/or more permanently containing computer-readable information. The communications system can permit data to be exchanged with the network and/or any other computer described above with respect to system environment.

The computer system can also comprise software elements, shown as being currently located within working memory, including an operating system and/or other code, such as an application program (which may be a client application, Web browser, middle tier/server application, etc.). It should be appreciated that alternative embodiments of computer system can have numerous variations from that described above. For example, customized hardware can be used and particular elements can be implemented in hardware, software, or both. Further, connection to other computing devices such as network input/output devices can be employed.

Computer readable storage media for containing code, or portions of code, executable by the computer system can include any appropriate media known or used in the art, such as but not limited to volatile/non-volatile and removable/non-removable media. Examples of computer-readable storage media include RAM, ROM, EEPROM, flash memory, CD-ROM, digital versatile disk (DVD) or other optical storage, magnetic cassettes, magnetic tape, magnetic disk storage or other magnetic storage devices, an any other medium that can be used to store data and/or program code and that can be accessed by a computer.

Although specific embodiments of the invention have been described above, various modifications, alterations, alternative constructions, and equivalents are within the scope of the invention. For example, embodiments of the present invention are not restricted to operation within certain specific data processing environments, but are free to operate within a plurality of data processing environments. Further, although embodiments of the present invention have been described with respect to certain flow diagrams and steps, it should be apparent to those skilled in the art that the scope of the present invention is not limited to the described diagrams/steps.

Yet further, although embodiments of the present invention have been described using a particular combination of hardware and software, it should be recognized that other combinations of hardware and software are also within the scope of the present invention.

The specification and drawings are, accordingly, to be regarded in an illustrative rather than restrictive sense. It will be evident that additions, subtractions, and other modifications may be made thereunto without departing from the broader spirit and scope of the invention as set forth in the following claims. For example, “coupon” has been used in an exemplary manner, and can also represent discount, rebates, or other offers of savings. The transceiver unit has been discussed as a stand-alone device, however, the functionality of the transceiver unit can be integrated into the component represented as 108 in FIG. 1. “UPC” has been used in an exemplary manner. Any type of code that uniquely identifies a product may be used instead of the UPC. The examples described herein discuss the processing of a single coupon. Multiple coupons are processed in a similar manner either one at a time or in batch.

What is claimed is:

1. A device connected to a point of sale terminal, comprising:
a first interface for communicating with a mobile device;
a second interface for receiving communications from a scanner;
a third interface for communicating with the point of sale terminal;
a fourth interface for communicating with a remote server;
memory, and
a processor configured for:
receiving a communication from the scanner via the second interface that includes a first UPC (Universal Product Code) identifier obtained by the scanner;
receiving a communication from the mobile device via the first interface that includes a UPC identifier and a price adjustment;
comparing a first UPC identifier received from the scanner and a second UPC identifier received from the mobile device; and
when the first UPC identifier received from the scanner and the second UPC identifier received from the mobile device match, transmitting the price adjustment to the point of sale terminal.

2. The device of claim 1, wherein the communication from the mobile device further comprises user identification information, and the processor is further configured for:
transmitting the user identification information to the remote server via the fourth interface; and
receiving additional price adjustment information from the remote server via the fourth interface.

3. The device of claim 1, wherein the processor is further configured for:
receiving a second communication from the scanner via the second interface that includes a second UPC identifier obtained by the scanner;
transmitting the second UPC identifier received from the scanner to the remote server via the fourth interface;
receiving a second price adjustment associated with the second UPC identifier from the remote server via the fourth interface; and
transmitting the second price adjustment to the point of sale terminal.

4. The device of claim 1, wherein the processor is further configured for:
receiving a second communication from the scanner via the second interface that includes a second UPC identifier obtained by the scanner;
transmitting the second UPC identifier received from the scanner to the remote server via the fourth interface;
receiving a third price adjustment associated with a third UPC identifier from the remote server via the fourth interface; and
transmitting a communication to the mobile device that includes the third UPC identifier and the third price adjustment to the mobile device.

5. The device of claim 1, wherein the processor is further configured for:
receiving information regarding products purchased and prices charged from the point of sale terminal via the third interface, and
transmitting a communication to the mobile device via the first interface that includes information regarding application of the price adjustment to a purchase of a product corresponding to the UPC identifier received from the mobile device.

6. The device of claim 1 wherein the processor is further configured for:
receiving information regarding products purchased and prices charged from the point of sale terminal via the third interface, and
transmitting information to the mobile device via the first interface regarding the products purchased and the prices charged.

7. A device connected to a point of sale terminal, comprising:
a first interface for communicating with a mobile device;
a second interface for receiving communications from a scanner;
a third interface for communicating with the point of sale terminal;
a fourth interface for communicating with a remote server;
memory, and
a processor configured for:
receiving a communication from the scanner via the second interface that includes a first UPC (Universal Product Code) identifier obtained by the scanner;
receiving a communication from the mobile device via the first interface that includes a user identification;
sending an identification communication via the fourth interface that includes the user identification;
receiving a UPC identifier and price adjustment information via the fourth interface;
comparing a first UPC identifier received from the scanner and the UPC identifier received from the mobile device; and
when the first UPC identifier received from the scanner and the second UPC identifier received from the mobile device match, transmitting the price adjustment information to the point of sale terminal.

8. The device of claim 7, wherein the communication from the mobile device further comprises user identification information, and the processor is further configured for:
transmitting the user identification information to the remote server via the fourth interface; and
receiving additional price adjustment information from the remote server via the fourth interface.

9. The device of claim 7, wherein the processor is further configured for:
receiving a second communication from the scanner via the second interface that includes a second UPC identifier obtained by the scanner;
transmitting the second UPC identifier received from the scanner to the remote server via the fourth interface;
receiving a second price adjustment associated with the second UPC identifier from the remote server via the fourth interface; and
transmitting the second price adjustment to the point of sale terminal.

10. The device of claim 7, wherein the processor is further configured for:
receiving a second communication from the scanner via the second interface that includes a second UPC identifier obtained by the scanner;
transmitting the second UPC identifier received from the scanner to the remote server via the fourth interface;
receiving a third price adjustment associated with a third UPC identifier from the remote server via the fourth interface; and
transmitting a communication to the mobile device that includes the third UPC identifier and the third price adjustment to the mobile device.

11. The device of claim 7, wherein the processor is further configured for:
receiving information regarding products purchased and prices charged from the point of sale terminal via the third interface, and
transmitting a communication to the mobile device via the first interface that includes information regarding application of the price adjustment information to a purchase of a product corresponding to the UPC identifier received from the mobile device.

12. The device of claim 7, wherein the processor is further configured for:
receiving information regarding products purchased and prices charged from the point of sale terminal via the third interface, and
transmitting information to the mobile device via the first interface regarding the products purchased and the prices charged.
